(19) United States
(12) Patent Application Publication
(10) Pub. No.: US 2016/0098416 A1
(43) Pub. Date: Apr. 7, 2016

(54) AUTO COMPLETE SEARCH BOX BASED ON THE USER'S CONTEXT TO REDUCE USER'S INPUT

(71) Applicant: Yahoo! Inc., Sunnyvale, CA (US)

(72) Inventor: Canhua Li, Beijing (CN)

(21) Appl. No.: 14/506,475

(22) Filed: Oct. 3, 2014

(51) Int. Cl. G06F 17/30; G06F 3/0481; H04L 29/08

(52) U.S. Cl. CPC G06F 17/3097; H04L 67/02; H04L 67/10; G06F 3/0481

(57) ABSTRACT

In one embodiment, contextual information pertaining to a user's context may be ascertained. A request for suggested search queries pertaining to the user's context may be received via a device. One or more key words that are pertinent to the context may be ascertained. One or more suggested search queries may be provided based, at least in part, upon the one or more key words, wherein the one or more suggested search queries are provided for presentation via the device prior to receiving input from the user via a search box of the device.

### BACKGROUND OF THE INVENTION

The disclosed embodiments relate generally to computer-implemented generation and presentation of suggested search queries.

Autocomplete is a feature provided by many web browsers, e-mail programs, and search-engine interfaces. The autocomplete feature completes a word or phrase that a user is typing without the user typing in the word or phrase completely.

In search engines, an autocomplete user interface feature typically provides users with suggested queries as they type their query in the search box. This type of feature often relies on matching algorithms that forgive entry errors. Such matching algorithms may search popular query lists to identify those queries that most closely match the text that has been typed in the search box.

### SUMMARY OF THE INVENTION

The disclosed embodiments support the generation of suggested search queries based upon a user's context. In this manner, input submitted by the user may be reduced.

In one embodiment, contextual information pertaining to a context of a user may be ascertained. A request for suggested search queries pertaining to the context may be received via a device. One or more key words that are pertinent to the context may be ascertained. One or more suggested search queries may be provided based, at least in part, upon the one or more key words, wherein the one or more suggested search queries are provided for presentation via the device prior to receiving input from the user via a search box of the device.

In another embodiment, a content item that is presented to a user may be identified. A request for suggested search queries pertaining to the content item may be received via a device. One or more key words that are pertinent to the content item may be ascertained. One or more suggested search queries may be provided based, at least in part, upon the one or more key words, wherein the one or more suggested search queries are provided for presentation via the device prior to receiving input from the user via a search box of the device.

In yet another embodiment, it may be determined that an indication that a user has switched to a search box from a previous context has been received. Suggested search queries that are pertinent to the context may be obtained. The suggested search queries may be presented prior to receiving input from the user via the search box.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a diagram illustrating an example system in which embodiments of the invention may be implemented.

FIG. 2A is a process flow diagram illustrating an example method of implementing an autosuggest feature in accordance with various embodiments.

FIG. 2B is a process flow diagram illustrating another example method of implementing an autosuggest feature in accordance with various embodiments.

FIG. 2C is a process flow diagram illustrating an example method of implementing an autosuggest feature based upon a user's context in accordance with various embodiments.

FIG. 2D is a process flow diagram illustrating another example method of implementing an autosuggest feature in accordance with various embodiments.

FIG. 3A is an example graphical user interface (GUI) illustrating an example context in which various embodiments may be implemented.

FIG. 3B is an example GUI presenting suggested queries for the context of FIG. 3A in accordance with various embodiments.

FIG. 4A is an example graphical user interface (GUI) illustrating another example context in which various embodiments may be implemented.

FIG. 4B is an example GUI presenting suggested queries for the context of FIG. 4A in accordance with various embodiments.

FIG. 5 is a schematic diagram illustrating an example embodiment of a network in which various embodiments may be implemented.

FIG. 6 is a schematic diagram illustrating an example client device in which various embodiments may be implemented.

FIG. 7 is a schematic diagram illustrating an example computer system in which various embodiments may be implemented.

### DETAILED DESCRIPTION OF THE SPECIFIC EMBODIMENTS

Reference will now be made in detail to specific embodiments of the disclosure. Examples of these embodiments are illustrated in the accompanying drawings. While the disclosure will be described in conjunction with these specific embodiments, it will be understood that it is not intended to limit the disclosure to these embodiments. On the contrary, it is intended to cover alternatives, modifications, and equivalents as may be included within the spirit and scope of the disclosure as defined by the appended claims. In the following description, numerous specific details are set forth in order to provide a thorough understanding of the disclosure. The disclosed embodiments may be practiced without some or all of these specific details. In other instances, well known process operations have not been described in detail in order not to unnecessarily obscure the disclosure. The Detailed Description is not intended as an extensive or detailed discussion of known concepts, and as such, details that are known generally to those of ordinary skill in the relevant art may have been omitted or may be handled in summary fashion

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

In recent years, the Internet has been a main source of information for millions of users. These users rely on the Internet to search for information of interest to them. One conventional way for users to search for information is to initiate a search query through a search service's web page. Typically, a user can enter a query including one or more search term(s) into an input box on the search web page and then initiate a search based on such entered search term(s). In response to the query, a web search engine generally returns an ordered list of search result documents.

A document may be defined as a Uniform Resource Locator (URL) that identifies a location at which the document can be located. The document may be located on a particular web site, as well as a specific web page on the web site. For instance, a first URL may identify a location of a web page at which a document is located, while a second URL may identify a location of a web site at which the document can be located.

Search engines often offer a search suggestion tool that helps users complete their query faster by predicting the next characters and words they will type. For example, as a user starts typing “sacr . . . ,” a drop-down window typically appears under the search box offering common completions and relevant suggestions such as “sacramento,” “sacramento airport,” and “sacred heart.” The user can then simply select from the list instead of typing in the complete search query.

The disclosed embodiments generate and provide search suggestions in the absence of receiving a portion of a search query from a user. More particularly, each search suggestion may be a suggested search query that relates to a current or recent context (e.g., browsing context). The terms “suggestion,” “search suggestion,” and “suggested search query” are used interchangeably.

### Example System

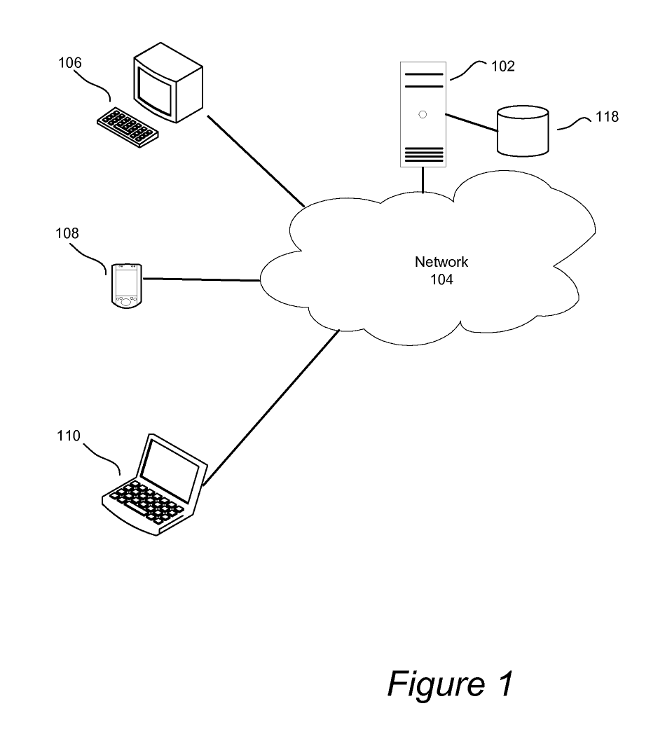

FIG. 1 is a diagram illustrating an example system in which various embodiments may be implemented. As shown in FIG. 1, the system may include one or more servers 102 associated with a web site such as a social networking web site. Examples of social networking web sites include Yahoo, Facebook, Tumblr, LinkedIn, Flickr, and Meme. The server(s) 102 may enable the web site to provide a variety of services to its users. More particularly, the server(s) 102 may include a web server, search server, and/or content server.

The server(s) 102 may provide targeted content to users of the web site. A content server may store content for presentation to users. For example, a content server may store web pages available on the Internet or data gathered via the Internet. As another example, a content server may be an “ad server” that stores online advertisements for presentation to users. “Ad serving” refers to methods used to place online advertisements on websites, in applications, or other places where users are more likely to see them, such as during an online session.

In addition, the server(s) 102 may provide suggested search queries for presentation via a device. In some embodiments, the suggested search queries may be provided upon receiving a request for the suggested search queries from the device. For example, the request may include an indication that a user has switched to a search box of a user interface presented via the device. As another example, the request may be received from the device prior to the user switching to a search box of a user interface presented via the device. Since the user has not submitted textual input into the search box, the server(s) 102 will not receive a search query or portion thereof from the device. As a result, the server(s) may generate the suggested search queries based, at least in part, upon contextual information, as will be described in further detail below.

The switching of the user to a search box may occur within the same device. Stated another way, the user may switch to a search box of a device from a previous context (e.g., content item) presented or accessed via the same device. For example, the user may be reading the news on a mobile device, then click on a search box on the mobile device. Alternatively, the switching of the user to the search box may occur among different devices. Thus, the user may switch to a search box of a device from a previous context (e.g., content item) presented or accessed via another device. For example, the user may be reading the news on a mobile device, and then click on the search box on a desktop computer.

In addition, the switching of the user to the search box may occur within the same application. For example, the user may open a Yahoo sports application, read an article pertaining to sports, then switch to a search box within the Yahoo sports application (e.g., within the same window). Alternatively, the switching of the user to the search box may occur between different applications. For example, the user may open Yahoo News, then switch to a search box within a Yahoo Search application.

A plurality of clients 106, 108, 110 may access a search application, for example, on a search server via network 104 and/or access a web service, for example, on a web server via a graphical user interface. The network 104 may take any suitable form, such as a wide area network or Internet and/or one or more local area networks (LAN's). The network 104 may include any suitable number and type of devices, e.g., routers and switches, for forwarding search or web object requests from each client to the search or web application and search or web results back to the requesting clients.

The disclosed embodiments may also be practiced in a wide variety of network environments (represented by network 104) including, for example, TCP/IP-based networks, telecommunications networks, wireless networks, etc. In addition, computer program instructions with which embodiments of the invention may be implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

A search application generally allows a user (human or automated entity) to search for information that is accessible via the network 104 and related to a search query including one or more search terms. More particularly, a graphical user interface including an input feature (e.g., input box, search box, or search query section) is presented to the client. Typically, the graphical user interface may present an input feature into which a user may type at least a portion of a search query including any number of search terms or portion thereof. The terms “input feature,” “input box,” “search box,” and “search query section” may be used interchangeably.

Companies are increasingly exploring ways to reduce user efforts in performing search-related tasks via search engines. Such efforts have resulted in the widely used auto-completion mechanism that automatically suggests possible completions of search queries while users are formulating their queries. However, the conventional auto-complete mechanism still requires the user to submit at least a portion of a search query.

In accordance with various embodiments, a user need not type a search query or portion thereof into the input feature of the graphical user interface. Rather, the user simply clicks on the input feature (e.g., by placing a cursor into a search box) to indicate that they are interested in submitting a search query. Suggested search queries (i.e., search suggestions) may then be automatically presented without receiving any further input (e.g., textual input) from the user. The user may then select one of the suggested search queries to submit to a search engine via the graphical user interface.

The search query may then be executed via one or more search applications (e.g., associated with search server and/or web server) and/or one or more data sources. Embodiments of the present invention may be employed with respect to any search application. The search application may be implemented on any number of servers although only a single server 102 is illustrated for clarity.

Upon receiving a search query, the search server 102 may identify and present the appropriate search results. For instance, the search server 102 may identify and present a plurality of hypertext links that identify content that is pertinent to the search query, as well as present a summary or abstract associated with the plurality of hypertext links.

Embodiments disclosed herein may be implemented via the search server (or other server) 102 and/or the clients 106, 108, 110. For example, various features may be implemented via a web browser and/or application on the clients 106, 108, 110. The disclosed embodiments may be implemented via software and/or hardware.

Generation of suggested queries may be performed by the server(s) 102 based, at least in part, upon a current or recent context (e.g., browsing context). The context may include a content item viewed or otherwise accessed by the user. Furthermore, the context may include an application accessed by the user, a web site accessed by the user, and/or an item purchased by the user. In addition, the context may further include geographic information such as a location from which the user is browsing. The context may also include information obtained or derived from a user profile. More particularly, the user profile may include information indicating the user's explicitly declared interests and/or inferred interests that are inferred from user behavior. For example, from data mining analysis, it may be ascertained that the user is not interested in basketball, but is interested in Apple's products. Examples of information that may be maintained in a user profile will be described in further detail below.

A variety of mechanisms may be implemented to support the generation of user profiles including, but not limited to, collecting or mining navigation history, stored documents, tags, or annotations, to provide a few examples. Profiles of users of a search engine, for example, may give a search engine provider a mechanism to retrieve annotations, tags, stored pages, navigation history, or the like, which may be useful for making relevance determinations of search results, such as with respect to a particular user.

In accordance with various embodiments, the server(s) 102 may have access to one or more user logs 118 (e.g., user databases) into which user information is retained for each of a plurality of users. This user information or a portion thereof may be referred to as a user profile. More particularly, the user profile may include public information that is available in a public profile and/or private information. The user logs 118 may be retained in one or more memories that are coupled to the server 102.

The user information retained in the user logs 118 may indicate a plurality of features for each user. More particularly, the features may include personal information such as demographic information (e.g., age and/or gender) and/or geographic information (e.g., residence address, work address, zip code, and/or area code). In addition, each time a user performs online activities such as clicking on a web page or an advertisement, or purchasing goods or services, information regarding such activity or activities may be retained as user data in the user logs 118. For instance, the user data that is retained in the user logs 118 may indicate the identity of web sites visited, identity of ads that have been selected (e.g., clicked on) and/or a timestamp. In addition, the features may indicate a purchase history with respect to one or more products, one or more types of products, one or more services, and/or one or more types of services. Additional features may indicate one or more interests of the user, which may be explicitly declared by the user and/or implicitly derived by the system.

The user logs 118 may further include query logs into which search information is retained. Each time a user performs a search on one or more search terms, information regarding such search may be retained in the query logs. For instance, the user's search request may contain any number of parameters, such as user or browser identity and the search terms, which may be retained in the query logs. Additional information related to the search, such as a timestamp, may also be retained in the query logs along with the search request parameters. When results are presented to the user based on the entered search terms, parameters from such search results may also be retained in the query logs. For example, an identity of the specific search results (e.g., URLs), such as the web sites, the order in which the search results are presented, whether each search result is a sponsored or algorithmic search result, the owner (e.g., web site) of each search result, and/or whether each search result is selected (i.e., clicked on) by the user (if any), and/or a timestamp may be retained in the query logs.

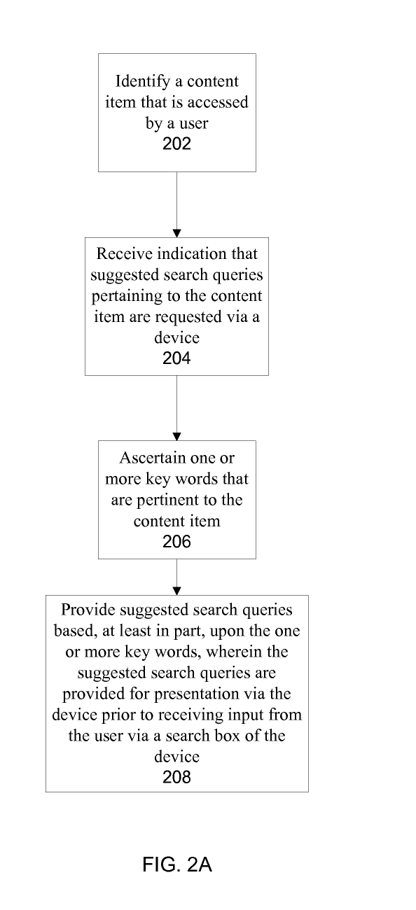

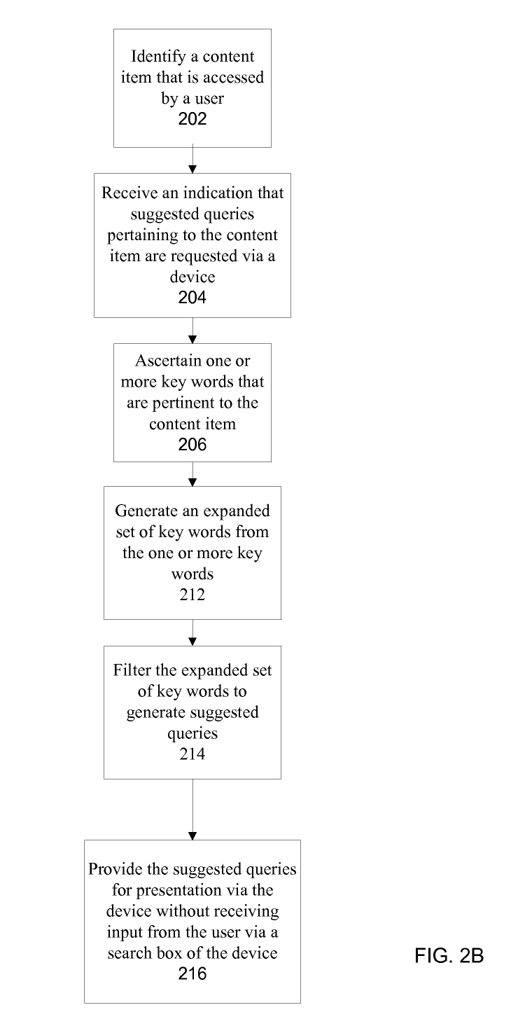

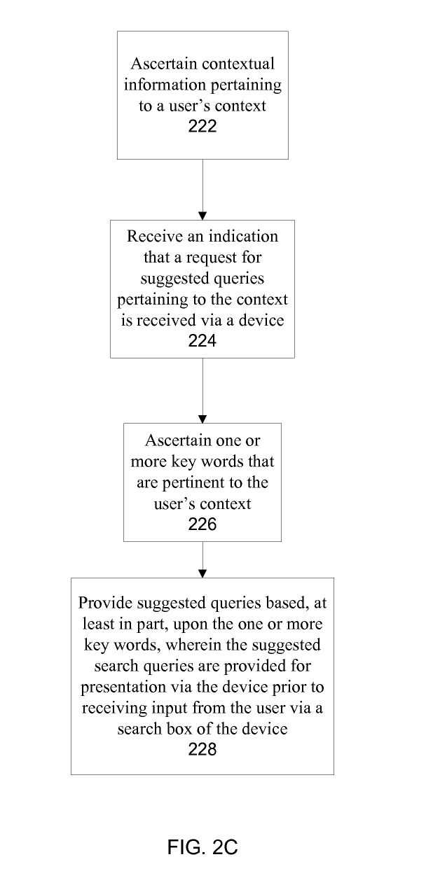

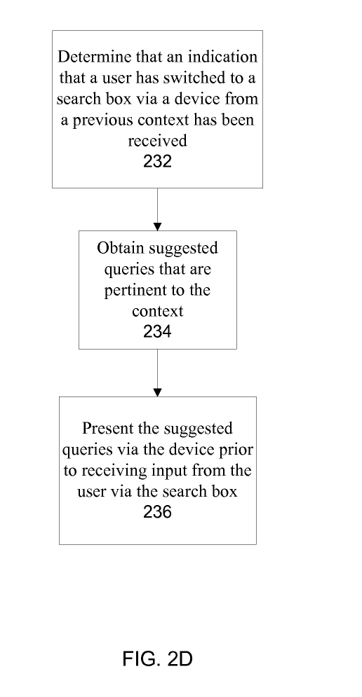

Suggested search queries may be generated and provided based upon a user's context. In one embodiment, the user's context includes a content item accessed by the user. Example methods of implementing an autosuggest feature based, at least in part, upon a content item accessed by the user will be described in further detail below with reference to FIGS. 2A-2B.

FIG. 2A is a process flow diagram illustrating an example method of implementing an autosuggest feature in accordance with various embodiments. A content item that is accessed by a user may be identified at 202. The content item may be accessed via a device via which the autosuggest feature is presented or another device. For example, the content item may be presented via a display of the device or another device.

A content item may include digital content including, but not limited to, text, an image, video, and/or audio. For example, the content item may include an image or article that has been accessed via a web page. As another example, the content item may include a photograph that is stored on the user's device or external memory.

The content item may be identified upon receiving an indication of a selection by a user of the content item from one of a plurality of content items. For example, the user may select a particular search result from a list of search results by clicking on a hypertext link corresponding to the search result. As another example, the user may open a file stored on the client's device.

An indication that suggested search queries pertaining to the content item are requested via a device may be obtained at 204. For example, a processor of the device may transmit an indication of a request for suggested search queries pertaining to the content item to a remotely located server. Such an indication may simply indicate that the user has accessed the content item via the device or another device. Alternatively, the indication may indicate that the user is interested in performing a search via the device. However, the indication may be received without receiving textual input from the user via a search box of the device. For example, it may be determined that the user has switched from the content item to a search box via the device. Thus, the indication that a user is interested in performing a search via the device may include an indication that the user has switched from the content item to a search box via the device. More particularly, an indication that the user has moved a cursor from the content item to the search box (e.g., by clicking in an area defined by the search box) may be received by a server from the device. For example, the device may detect input submitted via a keyboard, mouse, a touch-screen of the device, or other suitable mechanism. The user need not enter any text into the search box.

One or more key words that are pertinent to the content item may be ascertained at 206. The key words that are pertinent to the content item may be ascertained via various mechanisms that may be used separately or in combination with one another. More particularly, the key words may be ascertained from content of the content item and/or metadata of the content item.

The content of the content item may be analyzed to identify at least one key word. Various mechanisms may be applied to analyze content such as an image, text, and/or a HyperText Markup Language (HTML) file. More particularly, text or image(s) of the content item may be analyzed to ascertain a main subject of the content item, a category of the content item, and/or one or more entities (e.g., individuals, locations, organizations, times, events, physical objects, virtual objects) represented in the content item. Text snippets may be extracted from the content item.

In addition, the content item may include or have associated therewith metadata. For example, the metadata may include one or more tags that have been automatically or user-generated. As another example, the metadata may include one or more categories associated with the content item.

Suggested search queries may be provided at 208 based, at least in part, upon the one or more key words. For example, the suggested search queries may be provided by a server to the device for presentation via the device. The suggested search queries may be provided in response to the indication that suggested search queries are requested via the device. For example, the suggested search queries may be provided by a server to the device in response to the indication. As another example, the suggested search queries may be provided by the device upon determining that the user is interested in performing a search and therefore receiving the suggested search queries (e.g., by determining that the user has switched from the content item to a search box). The suggested search queries may be advantageously presented via the device prior to receiving input (e.g., textual input) from the user via a search box. In other words, the user need not submit textual input via a search box to receive suggested queries. The suggested search queries may be presented in a segment of the GUI in close proximity to (e.g., below) a search box.

The suggested search queries may be generated based, at least in part, upon the key words. Thus, the suggested search queries may include at least one of the key words and/or one or more further terms. In some embodiments, the suggested search queries may be generated upon determining that the user has switched from the content item to the search box. In other embodiments, the suggested search queries may be generated automatically each time a user selects or clicks on (e.g., views) a content item.

In accordance with various embodiments, the key words may be processed to generate the suggested search queries. More particularly, processes such as expansion, filtering, and/or aggregation may be performed to generate the suggested search terms. The expansion and/or filtering may be performed based, at least in part, upon additional information pertaining to the current or recent context (e.g., location of the device/user), a user profile of the user, and/or popular or trending key words, as will be described in further detail below.

Expansion may include identifying one or more additional key words that were not initially ascertained from the content item. Expansion may be performed using popular or trending key words, the current or recent browsing context (e.g., location of the device/user), and/or the user profile. More particularly, where the user is logged in via a user account, the user may be identified and a corresponding user profile may be accessed. Where the user is not logged in, a browser identifier or other identifier may be used to access a user profile.

Filtering may include eliminating key word(s) from the key words originally identified from the content item and/or from the additional key words resulting from performing expansion of the key words. Filtering may be performed using popular or trending key words, the current or recent context (e.g., location of the user/device), and/or the user profile. More particularly, a set of key words including at least a portion of the key words that have been originally identified from the content item may be ranked based, at least in part, upon the popular or trending key words, the current or recent context (e.g., location of the user/device), and/or the user profile to generate the suggested search queries. The set of key words may or may not include additional key words resulting from performing expansion of the key words. The suggested search queries may include at least a portion of the set of key words according to the ranking that has been performed.

Popular key words may be identified based upon information such as search queries submitted by users to the search server over a period of time, tags that are generated or selected by users over the period of time, and/or links that are selected by users over the period of time. Popular key words may be identified, for example, by ranking terms including search terms that are submitted to the search server over a period of time, the tags, and the selected links according to frequency of submission or use. Those search terms, tags, or links that are used most frequently may be identified as popular key words.

Trending key words may be derived from popular topics such as events or people that are being discussed on the Internet or via a particular web site. Thus, trending key words may be identified by ranking such trending topics to identify the most frequently discussed topics.

The current or recent context may indicate further information such as a location of the device/user and/or type of location. For example, the current or recent context may indicate a city, state, or zip code. As another example, the current or recent browsing context may indicate that the location is a sports arena, school, or beach.

In some embodiments, the current or recent context may include search terms that have been submitted by the user that resulted in the selection of the content item. For example, the user may enter the terms “fashion show” and perform an image search to obtain a list of search results from which the content item is selected.

A user profile of the user may be accessed to ascertain further information about the user. For example, the user profile may include demographic information (e.g., age and/or gender) and/or geographic information (e.g., residence address, work address). As another example, the user profile may include information pertaining to the user's prior browsing history, purchase history, and/or interests.

FIG. 2B is a process flow diagram illustrating another example method of implementing an autosuggest feature in accordance with various embodiments. As described above, a content item that is accessed by a user may be identified at 202. An indication that suggested search queries pertaining to the content item are requested via a device may be received at 204. For example, an indication that the user has switched from the content item to a search box of the device may be received. As another example, an indication that the user has accessed the content item may be received, enabling the device to receive the suggested search queries prior to the user switching to the search box. One or more key words that are pertinent to the content item may be ascertained at 206.

In some embodiments, the suggested search queries may be generated automatically each time a user selects or clicks on (e.g., views) a content item. In other embodiments, the suggested search queries may be generated upon determining that the user has switched from the content item to the search box.

As discussed above, suggested search queries may be generated by performing an expansion and filtering process. An expanded set of key words may be generated from the one or more key words at 212. Expansion may be performed using popular and/or trending key words, the current or recent user context (e.g., location), and/or the user profile. An aggregation process may also be performed to group similar key words. The expanded set of key words may be filtered to generate suggested queries at 214. Filtering may be performed using popular and/or trending key words, the current or recent context, and/or the user profile.

The suggested queries may be provided at 216 without receiving input from the user via a search box of the device. For example, the suggested queries may be provided for presentation via the device upon receiving the indication that the user has switched from the content item to the search box.

In the examples described above, suggested queries are determined based, at least in part, upon a content item that is being accessed by a user or has recently been accessed by the user. However, the suggested queries may also be generated based upon contextual information that need not include or be derived from a content item accessed by the user. For example, the contextual information may indicate a web site that is being accessed by the user or has recently been accessed by the user, a purchase that the user has recently completed via a web site, or an application that the user has recently accessed.

FIG. 2C is a process flow diagram illustrating an example method of implementing an autosuggest feature based upon contextual information pertaining to a user's context in accordance with various embodiments. Contextual information pertaining to a user's context with may be ascertained at 222. The user's context may be a current or recent context of the user with respect to a client device and/or additional device(s). In other words, the disclosed embodiments may operate to enable a server to generate suggested queries for a user that is using multiple devices. The contextual information may indicate or pertain to a particular application that the user has recently accessed via the client device or a different device, a particular item that the user has purchased via the client device or a different device, a particular web site that was recently accessed via the client device or a different device, and/or a content item that was recently accessed via the client device or a different device. In addition, the contextual information may include information obtained from or derived from a user profile associated with the user and/or indicate a current location of the user/client device.

An indication that suggested search queries pertaining to the context are requested via a device may be obtained at 224. For example, a processor of the device may transmit an indication of a request for suggested search queries pertaining to the context to a remotely located server. Such an indication may simply indicate that the user has accessed a context, which may include a content item, application, or web site. Alternatively, the indication may indicate that the user is interested in performing a search via the device. The indication may be received without receiving textual input from the user via a search box. For example, it may be determined that the user has switched from the context (e.g., content item) to a search box via the device. Thus, the indication that a user is interested in performing a search via the device may include an indication that the user has switched to a search box from the context via the device. More particularly, the user may click on the search box using an input mechanism. For example, the input mechanism may include a keyboard or mouse. As another example, where the client device includes a touch-sensitive display, the input mechanism may include a stylus or hand of the user.

One or more key words that are pertinent to the context may be ascertained at 226. The key words may be obtained from the contextual information. For example, the key words may be obtained from content and/or metadata of a content item that the user was accessing via the client device, a web site that the user was accessing via the client device, an application that the user was accessing via the client device, and/or an item that the user has purchased via the client device.

Suggested queries may be provided based, at least in part, upon the one or more key words at 228, where the suggested search queries are provided for presentation via the device prior to receiving input (e.g., textual input) from the user via a search box. As discussed above, the suggested queries may be generated by performing expansion, aggregation, and/or filtering processes. Expansion and/or filtering processes may be performed using popular or trending key words and/or further information such as the location of the user/client device and/or information obtained from or derived from the user profile of the user.

FIG. 2D is a process flow diagram illustrating another example method of implementing an autosuggest feature in accordance with various embodiments. It may be determined that a user is interested in receiving suggested search queries, where such a determination is made in the absence of receiving textual input from the user. More particularly, it may be determined at 232 that an indication that a user has switched to a search box via a device from a previous context has been received. Such a determination may be made by the device and/or a remotely located server associated with a search service for which the search box is presented. More particularly, the device may determine that the user has clicked on the search box using an input mechanism. For example, the device may detect input received via a keyboard or mouse. As another example, where the device includes a touch-sensitive display, the device may detect input received via the touch-sensitive display. The device may transmit an indication that the user has switched to a search box to the server. Thus, the server may determine that the indication that the user has switched to a search box has been received.

As set forth above, in one embodiment, the context may include a content item accessed via the device. In other embodiments, the context may include an application accessed via the device, a web site accessed via the device, and/or an item purchased via the device.

Suggested search queries that are pertinent to the context may be obtained at 234. The suggested search queries may be obtained by the device and/or a remotely located server. For example, the suggested search queries may be obtained by a server upon receiving an indication that suggested search queries are requested by the device. As another example, the suggested search queries may be obtained by the device from a remotely located server via a network. As discussed above, the device may transmit a request for the suggested search queries to the server and receive the suggested search queries from the server in response to the request. The request may identify the user (e.g., browser identifier), enabling the server to access a user profile associated with the user. In one embodiment, the request may be transmitted automatically upon determining that the user has switched to the search box. Thus, the request may indicate that the user has switched to the search box. In another embodiment, the request may be transmitted automatically, upon access or a request for access, by the user, of a context, which may include a content item, application, or web site. In other words, the request may be transmitted automatically prior to the switching of the user to the search box. The suggested search queries may be generated by the server based, at least in part, upon the context, as described above.

The suggested search queries may be presented via the device at 326 prior to receiving input from the user via the search box. More particularly, the suggested search queries may be transmitted by a server associated with a search service to the device. The suggested search queries may be presented via a display of the device or a display coupled to the device.

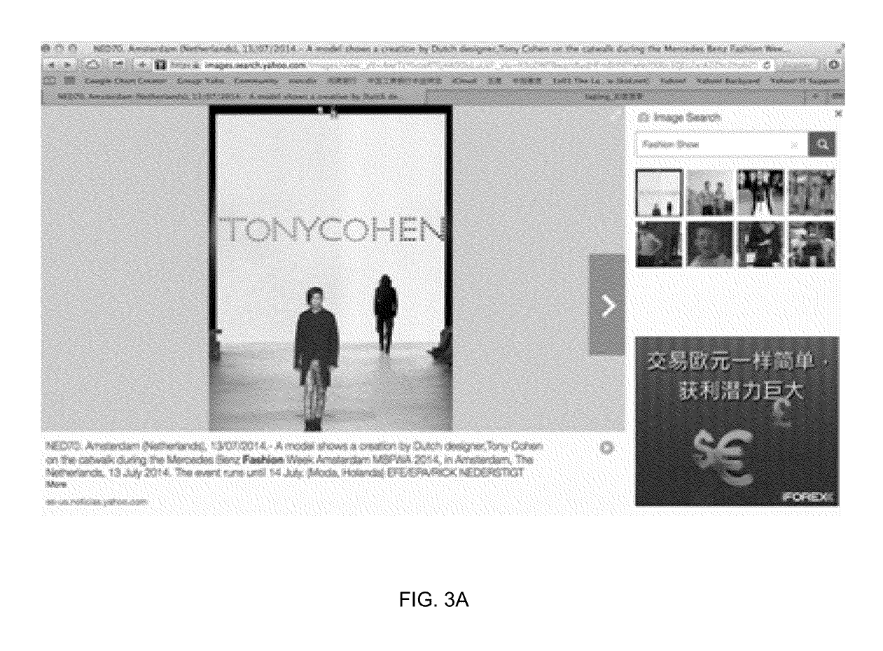

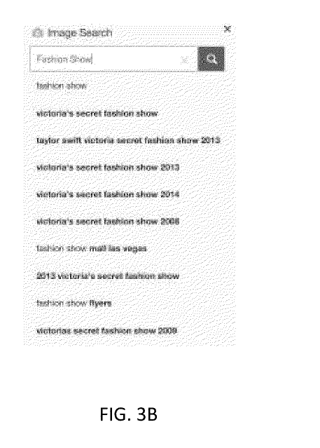

FIG. 3A is an example graphical user interface (GUI) illustrating an example context in which various embodiments may be implemented. As shown in this example, a user may click on or otherwise view an image. For example, the image may be identified by the user by performing an image search.

Key words identified from the content of the content item and/or metadata associated with the content item may include one or more key words. For example, the key words may include a date and/or time pertaining to the content item (e.g., of an event), a location (e.g., of an event), a title of an event that may be represented by the content item or identified within the content item, a name of one or more individual(s) represented by the content item or identified within the content item, and/or a wiki identifier.

Where a user performs an image search, the image may actually be a portion of a content item. More particularly, the content item may be a web page or article that includes the image. Thus, the content item may include text, as well as the image. Such text may include descriptive information pertaining to the image. For example, the descriptive information may include a summary or abstract corresponding to the image.

In this example, the content item includes descriptive text that corresponds to the image. From the descriptive text, it is possible to ascertain that the image includes a photo showing a creation by Dutch designer Tony Cohen, and the image was taken at “Mercedes Benz Fashion Week 2014” in Amsterdam on “13 Jul. 2014.” Therefore, a set of key words may be obtained, at least in part, from the descriptive text.

In addition, the image may have associated therewith a set of metadata. Such metadata may include tags that have been automatically and/or user-generated. Moreover, the metadata may include one or more categories associated with the image. For example, the image may be categorized as being from a “Fashion show.” Thus, the set of key words may include “Fashion show” corresponding to the category in which the image has been categorized.

Before expansion, the key words may include “Mercedes Benz Fashion Week,” “Tony Cohen,” and “13 Jul. 2014.” The set of key words may be expanded, aggregated, and/or filtered to generate a set of suggested search queries. For example, expansion of the set of key words may generate suggested search terms “Mercedes Benz Fashion Week,” “Mercedes Benz Fashion Week 2014,” “Mercedes Benz Fashion 13 Jul. 2014,” and “Tony Cohen.”

When the user switches to the search box, suggested search queries are typically not presented to the user. Rather, suggested search queries are typically presented only after the user enters at least several characters into the search box.

In accordance with various embodiments, when the user switches to the search box, suggested queries may be automatically presented. FIG. 3B is an example GUI presenting suggested queries for the context of FIG. 3A in accordance with various embodiments. In this example, it may be ascertained from the user's profile that the user purchases goods from Victoria's Secret and that the user is interested generally in fashion. As a result, the suggested queries may include those pertaining to fashion shows, as well as Victoria's Secret fashion shows. Key words pertaining to the particular fashion show shown in the image of FIG. 3A may be filtered. For example, the key words pertaining to the specific designer (e.g., Tony Cohen) and the specific fashion show represented in the image (e.g., Mercedes Benz) may be filtered such that the suggested search queries presented do not include the specific designer or specific fashion show.

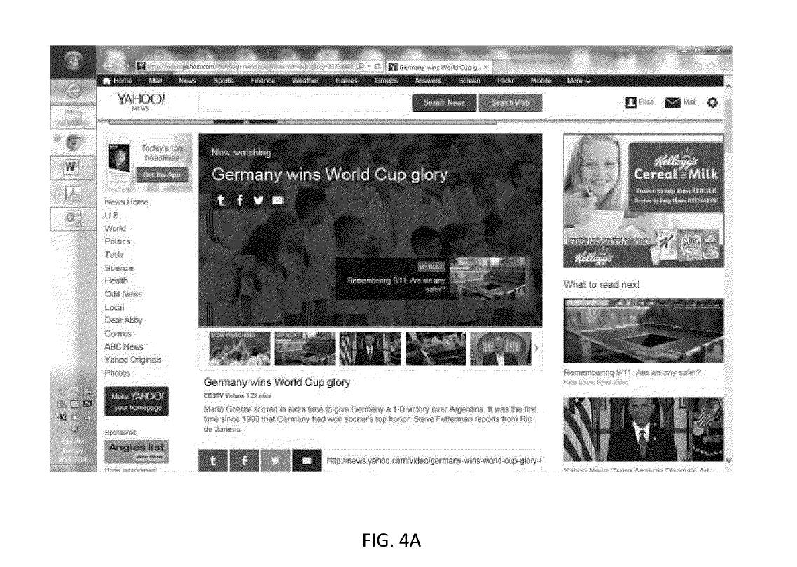

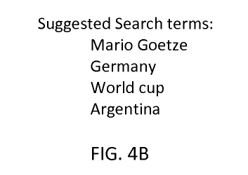

FIG. 4A is an example graphical user interface (GUI) illustrating another example context in which various embodiments may be implemented. In this example, the user view a news article entitled, “Germany wins world cup glory.” In the news article, there is a reference to the World Cup, the soccer player Mario Goetze, Germany, and Argentina. Thus, before expansion, the key words may include “Mario Goetze,” “Germany,” “World Cup,” and “Argentina.”

FIG. 4B is an example GUI presenting suggested queries for the context of FIG. 4A in accordance with various embodiments. As shown in this example, after expansion of the key words, the suggested queries may include “Mario Goetze,” “Germany soccer team,” and “Germany vs Argentina 2014.”

The disclosed embodiments enable suggested search queries to be presented to a user without requiring the user to enter characters into a search box associated with a search engine. More particularly, upon determining that the user has an interest in performing a search, suggested search queries may be presented within a vicinity of the search box. Accordingly, through the disclosed embodiments, search efforts of a user that has shown an interest in performing a search may be minimized.

Network

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content Distribution Network

A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Peer-to-Peer Network

A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

Wireless Network

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Internet Protocol

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

Network Architecture

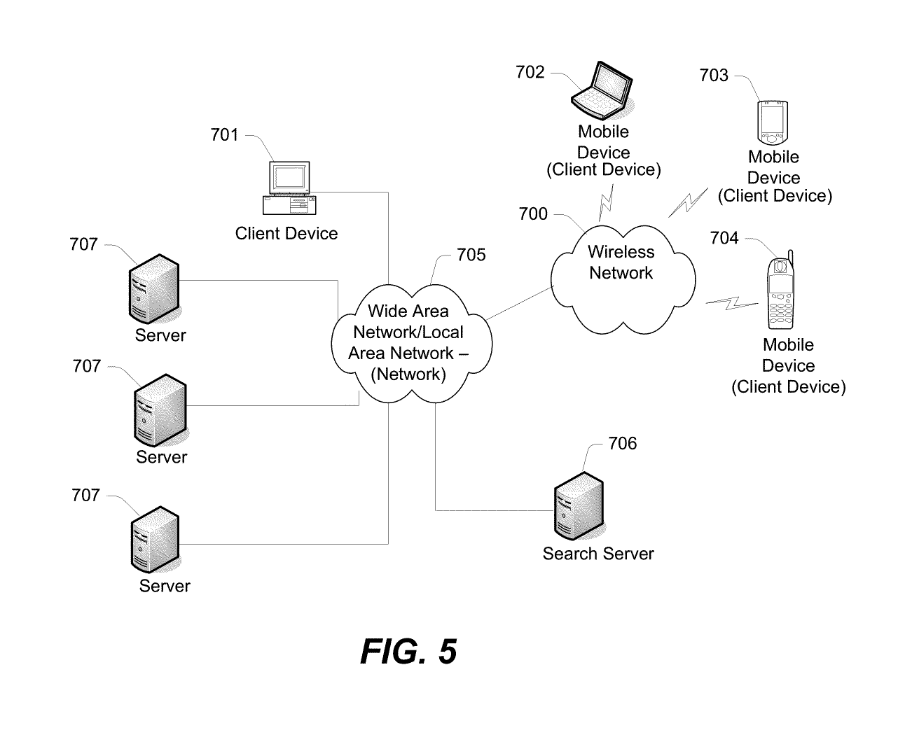

The disclosed embodiments may be implemented in any of a wide variety of computing contexts. FIG. 5 is a schematic diagram illustrating an example embodiment of a network. Other embodiments that may vary, for example, in terms of arrangement or in terms of type of components, are also intended to be included within claimed subject matter. Implementations are contemplated in which users interact with a diverse network environment. As shown, FIG. 5, for example, includes a variety of networks, such as a LAN/WAN 705 and wireless network 700, a variety of devices, such as client devices 701-704, and a variety of servers such as content server(s) 707 and search server 706. The servers may also include an ad server (not shown). As shown in this example, the client devices 701-704 may include one or more mobile devices 702, 703, 704. Client device(s) 701-704 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

The disclosed embodiments may be implemented in some centralized manner. This is represented in FIG. 5 by server(s) 707, which may correspond to multiple distributed devices and data store(s). The server(s) 707 and/or corresponding data store(s) may store user account data, user information, and/or content.

Server

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content Server

A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

Client Device

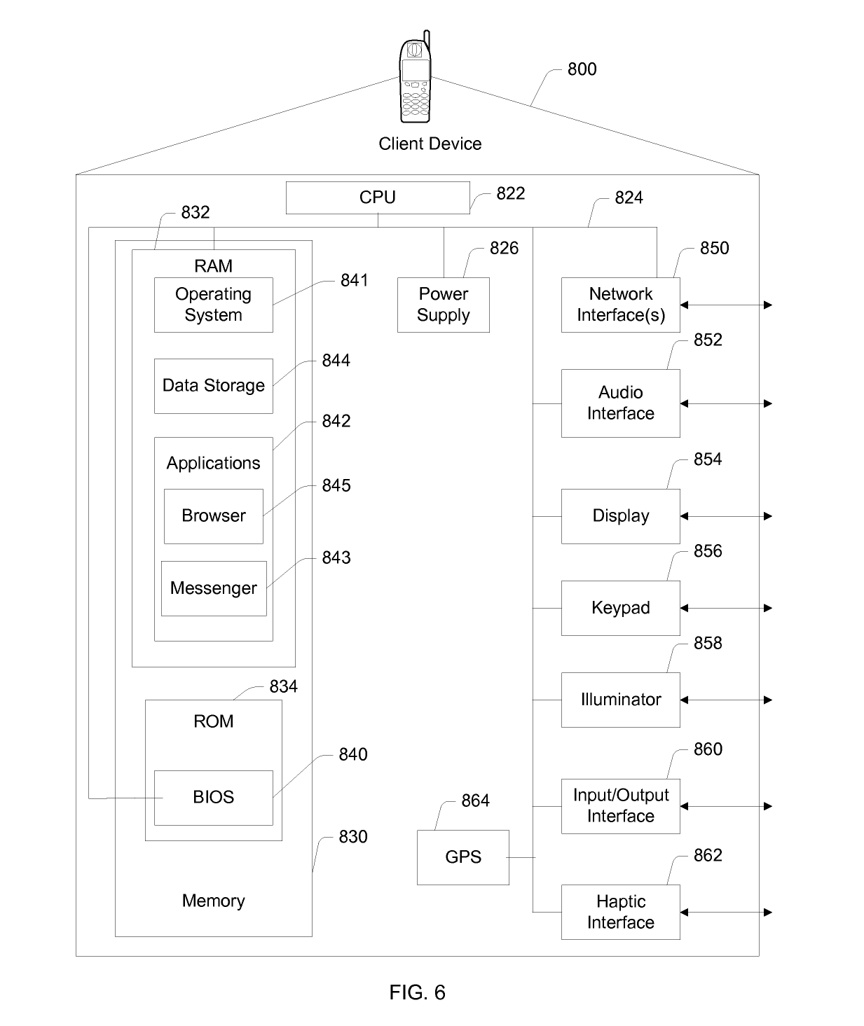

FIG. 6 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. A portable device may also be referred to as a mobile device or handheld device.

As shown in this example, a client device 800 may include one or more central processing units (CPUs) 822, which may be coupled via connection 824 to a power supply 826 and a memory 830. The memory 830 may include random access memory (RAM) 832 and read only memory (ROM) 834. The ROM 834 may include a basic input/output system (BIOS) 840.

The RAM 832 may include an operating system 841. More particularly, a client device may include or may execute a variety of operating systems, including a personal computer operating system, such as a Windows, iOS or Linux, or a mobile operating system, such as iOS, Android, or Windows Mobile, or the like. The client device 800 may also include or may execute a variety of possible applications 842 (shown in RAM 832), such as a client software application such as messenger 843, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 800 may also include or execute an application to communicate content, such as, for example, textual content, multimedia content, or the like, which may be stored in data storage 844. A client device may also include or execute an application such as a browser 845 to perform a variety of possible tasks, such as browsing, searching, playing various forms of content, including locally stored or streamed video, or games (such as fantasy sports leagues).

The client device 800 may send or receive signals via one or more interface(s). As shown in this example, the client device 800 may include one or more network interfaces 850. The client device 800 may include an audio interface 852. In addition, the client device 800 may include a display 854 and an illuminator 858. The client device 800 may further include an Input/Output interface 860, as well as a Haptic Interface 862 supporting tactile feedback technology.

The client device 800 may vary in terms of capabilities or features. Claimed subject matter is intended to cover a wide range of potential variations. For example, a cell phone may include a keypad such 856 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 864 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

In some embodiments, an identity of the user (e.g., owner) of the client device may be statically configured. Thus, the device may be keyed to an owner or multiple owners. In other embodiments, the device may automatically determine the identity of the user of the device. For instance, a user of the device may be identified by deoxyribonucleic acid (DNA), retina scan, and/or finger print.

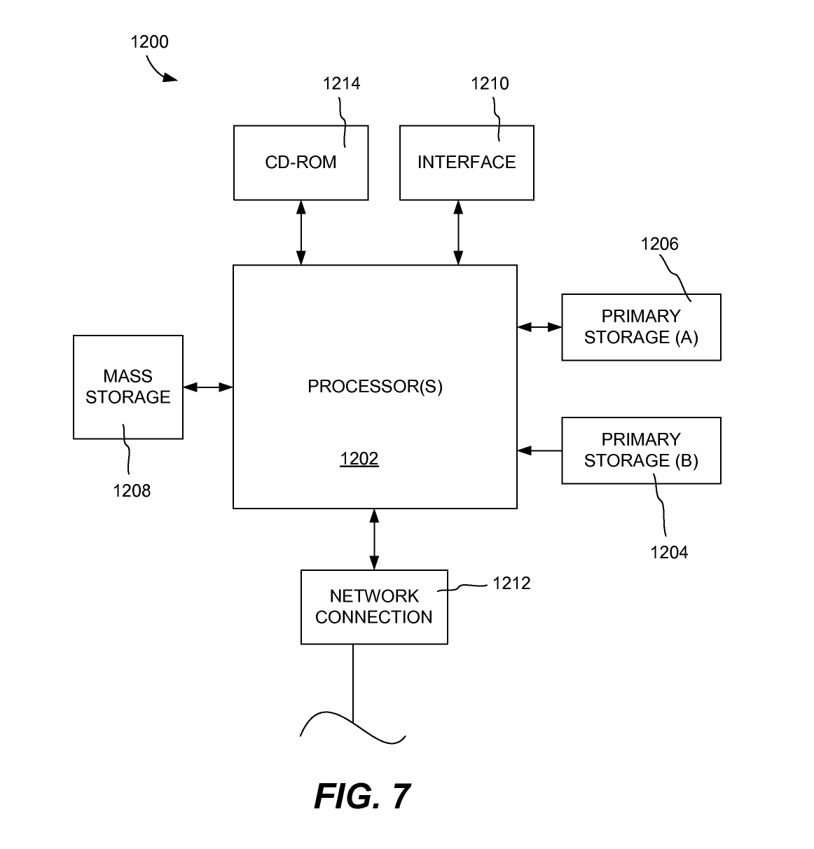

FIG. 7 illustrates a typical computer system that, when appropriately configured or designed, can serve as a system via which various embodiments may be implemented. The computer system 1200 includes any number of CPUs 1202 that are coupled to storage devices including primary storage 1206 (typically a RAM), primary storage 1204 (typically a ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as optical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software and/or hardware system, such as a web-based server or desktop computer system. Moreover, a system implementing various embodiments may be a portable device, such as a laptop or cell phone. An apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
identifying a content item that is presented to a user via a device or another device;
receiving a request for suggested search queries pertaining to the content item via the device;
ascertaining one or more key words that are pertinent to the content item; and
providing one or more suggested search queries based, at least in part, upon the one or more key words, wherein the one or more suggested search queries are provided for presentation via the device prior to receiving input from the user via a search box of the device.

2. The method as recited in claim 1, wherein the request for suggested search queries pertaining to the content item comprises an indication that the user has switched from the content item to the search box of the device.

3. The method as recited in claim 1, wherein the request for suggested search queries pertaining to the content item comprises an indication that the content item has been accessed by the user.

4. The method as recited in claim 1, wherein ascertaining one or more key words that are pertinent to the content item comprises:
analyzing the content item to identify a primary subject of the content item.

5. The method as recited in claim 1, wherein ascertaining one or more key words that are pertinent to the content item comprises:
extracting at least a portion of the key words from the content item, a category associated with the content item, or a set of tags associated with the content item.

6. The method as recited in claim 1, further comprising:
generating the suggested search queries based, at least in part, upon the one or more key words.

7. The method as recited in claim 6, wherein generating the suggested queries comprises:
expanding the one or more key words based, at least in part, upon at least one of a user profile of the user, popular or trending key words, or a location of the device.

8. An apparatus, comprising:
a processor; and
a memory, at least one of the processor or the memory being configured to:
ascertain contextual information pertaining to a context of a user;
receive a request for suggested search queries pertaining to the context via a device;
ascertain one or more key words that are pertinent to the context; and
provide one or more suggested search queries based, at least in part, upon the one or more key words, wherein the one or more suggested search queries are provided for presentation via the device prior to receiving input from the user via a search box of the device.

9. The apparatus as recited in claim 8, wherein the request for suggested search queries pertaining to the context comprises an indication that the user has switched from the context to the search box via the device.

10. The apparatus as recited in claim 8, wherein the request for suggested search queries pertaining to the context comprises an indication that the user has accessed the context.

11. The apparatus as recited in claim 8, wherein the context comprises a content item accessed via the device, a content item accessed via another device, an application accessed via the device, or an application accessed via another device.

12. The apparatus as recited in claim 8, wherein the context comprises information obtained or derived from a user profile of the user.

13. The apparatus as recited in claim 8, wherein the context comprises a location of the device.

14. The apparatus as recited in claim 8, at least one of the processor or the memory being further configured to expand the one or more key words to generate the suggested search queries based, at least in part, upon popular or trending key words.

15. A non-transitory computer-readable storage medium storing thereon computer-readable instructions, comprising:
instructions for determining that an indication that a user has switched to a search box via a device from a previous context has been received;
instructions for obtaining suggested search queries that are pertinent to the context; and
instructions for presenting the suggested search queries via the device prior to receiving input from the user via the search box.

16. The non-transitory computer-readable storage medium as recited in claim 15, wherein the previous context comprises a content item.

17. The non-transitory computer-readable storage medium as recited in claim 15, wherein the previous context comprises another device.

18. The non-transitory computer-readable storage medium as recited in claim 15, further comprising:
instructions for transmitting a request for the suggested search queries to a server associated with a search service.

19. The non-transitory computer-readable storage medium as recited in claim 18, wherein the request is transmitted automatically upon determining that the user has switched to the search box.

20. The non-transitory computer-readable storage medium as recited in claim 18, wherein the request is transmitted automatically upon identification of a content item accessed via the device.
